(19) United States
(12) Patent Application Publication
(10) Pub. No.: US 2008/0218650 A1
(43) Pub. Date: Sep. 11, 2008

(54) LIQUID CRYSTAL DEVICE, METHOD OF DRIVING LIQUID CRYSTAL DEVICE AND ELECTRONIC APPARATUS

(75) Inventors: Takeshi KOSHIHARA, Suwa-shi (JP); Sumio UTSUNOMIYA, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/035,140

(22) Filed: Feb. 21, 2008

(30) Foreign Application Priority Data
Mar. 6, 2007 (JP) 2007-055190

(51) Int. Cl. G02F 1/1343

(52) U.S. Cl. 349/39

(57) ABSTRACT

A liquid crystal device includes a first substrate, a second substrate, liquid crystal, a detection electrode, a liquid crystal capacitor, a storage capacitor, a switching element, a selection circuit, a signal supplying circuit, and an electric potential control circuit. The first substrate is opposed to the second substrate. The liquid crystal is sealed in a gap between the first substrate and the second substrate. The detection electrode is provided on a side of the first substrate, opposite to a side on which the liquid crystal is provided. The detection electrode detects a contact on the basis of variation in capacitance. The liquid crystal capacitor includes a pixel electrode, an opposite electrode, and the liquid crystal between the pixel electrode and the opposite electrode. The storage capacitor includes a first electrode and a second electrode that is connected to the pixel electrode. The switching element is connected between the pixel electrode and a signal line. The selection circuit conducts the switching element during a selection period and interrupts conduction of the switching element after the selection period has elapsed. The signal supplying circuit supplies a data electric potential (for example, an electric potential VDP or an electric potential VDN shown in FIG. 4) corresponding to positive polarity writing or negative polarity writing to the signal line during the selection period. The electric potential control circuit shifts an electric potential of the first electrode to a high level side after a selection period in which a data electric potential corresponding to the positive polarity writing is supplied to the signal line has elapsed, and shifts an electric potential of the first electrode to a low level side after a selection period in which a data electric potential corresponding to the negative polarity writing is supplied to the signal line has elapsed.

### BACKGROUND

1. Technical Field

The present invention relates to a technology for driving a liquid crystal device in which an electrode (hereinafter, “detection electrode”) is formed to detect a contact of a finger or a pen on the basis of variation in capacitance.

2. Related Art

An existing liquid crystal device that is provided with a capacitance type touch panel has been proposed. A detection electrode is arranged in proximity to the liquid crystal device, so that a capacitor is associated between the detection electrode and elements in the liquid crystal device (for example, electrode or wiring). Thus, there is a problem that noise is generated in the detection electrode because of changes in signals used for image display in the liquid crystal device. Japanese Unexamined Patent Application Publication No. 2006-146895 describes a technology for removing noise due to variation in electric potential of an opposite electrode from a detection signal on the basis of variation in capacitance of the detection electrode.

However, in the technology described in JP-A-2006-146895, a complex circuit is required for removing noise from the detection signal, so that there is a problem that a circuit size increases and manufacturing costs also increase.

### SUMMARY

An advantage of some aspects of the invention is that it suppresses an influence of noise generated in the detection electrode with a simple structure.

An aspect of the invention provides a liquid crystal device. The liquid crystal device includes a first substrate, a second substrate, liquid crystal, a detection electrode, a liquid crystal capacitor, a storage capacitor, a switching element, a selection circuit, a signal supplying circuit, and an electric potential control circuit. The first substrate is opposed to the second substrate. The liquid crystal is sealed in a gap between the first substrate and the second substrate. The detection electrode is provided on a side of the first substrate, opposite to a side on which the liquid crystal is provided. The detection electrode detects a contact on the basis of variation in capacitance. The liquid crystal capacitor includes a pixel electrode, an opposite electrode, and the liquid crystal between the pixel electrode and the opposite electrode. The storage capacitor includes a first electrode and a second electrode that is connected to the pixel electrode. The switching element is connected between the pixel electrode and a signal line. The selection circuit conducts the switching element during a selection period and interrupts conduction of the switching element after the selection period has elapsed. The signal supplying circuit supplies a data electric potential (for example, an electric potential VDP or an electric potential VDN shown in FIG. 4) corresponding to positive polarity writing or negative polarity writing to the signal line during the selection period. The electric potential control circuit shifts an electric potential of the first electrode to a high level side after a selection period in which a data electric potential corresponding to the positive polarity writing is supplied to the signal line has elapsed, and shifts an electric potential of the first electrode to a low level side after a selection period in which a data electric potential corresponding to the negative polarity writing is supplied to the signal line has elapsed.

In the above configuration, because the electric potential of the pixel electrode is set to an electric potential that is obtained by varying a data electric potential on the basis of an electric potential of the first electrode after the selection period has elapsed, in comparison with a configuration in which the electric potential of the first electrode is fixed, range of variation necessary to a data electric potential is reduced. Thus, it is possible to suppress noise generated in the detection electrode due to variation in data electric potential. The liquid crystal device according to the aspects of the invention may be used in various electronic apparatuses, such as a personal computer or a cellular phone.

In the aspect of the invention, the detection electrode may be formed on a surface of the first substrate, which is opposite to a surface on which the liquid crystal is provided. According to the above aspect, noise of the detection electrode due to variation in data electric potential is suppressed while a configuration of the liquid crystal device is simplified in comparison with a configuration in which the detection electrode is formed on a substrate independent of the first substrate.

In the aspect of the invention, the pixel electrode may be formed on a surface of the second substrate, which is opposite to the first substrate, and the opposite electrode may be formed between the pixel electrode and the first substrate and maintained at a constant electric potential. In the above aspect, because the opposite electrode functions as a shield for suppressing an influence of a signal that sets an electric potential of the pixel electrode (for example, a selection signal Y[i] or a data signal X[j]) on the detection electrode, it is possible to further effectively suppress noise of the detection electrode. Note that the opposite electrode may be formed on any one of the first electrode and the second electrode.

Another aspect of the invention provides a method of driving a liquid crystal device that includes a first substrate, a second substrate opposed to the first substrate, liquid crystal sealed in a gap between the first substrate and the second substrate, a liquid crystal capacitor that has a pixel electrode, an opposite electrode and the liquid crystal between the pixel electrode and the opposite electrode, a storage capacitor that has a first electrode and a second electrode connected to the pixel electrode, and a detection electrode formed on a side of the first substrate, opposite to a side on which the liquid crystal is provided, wherein the detection electrode is used for detecting a contact on the basis of variation in capacitance. The method of driving the liquid crystal device according to the aspect of the invention includes connecting the pixel electrode and the signal line during a selection period and interrupting the pixel electrode from the signal line after the selection period has elapsed, supplying the signal line during the selection period with a data electric potential corresponding to positive polarity writing or negative polarity writing, and shifting an electric potential of the first electrode to a high level side after a selection period in which a data electric potential corresponding to the positive polarity writing is supplied to the signal line has elapsed and shifting an electric potential of the first electrode to a low level side after a selection period in which a data electric potential corresponding to the negative polarity writing is supplied to the signal line has elapsed. According to the above driving method, the same function and advantageous effects as those of the liquid crystal device according to the aspects of the invention are obtained.

### BRIEF DESCRIPTION OF THE DRAWINGS

The invention will be described with reference to the accompanying drawings, wherein like numbers reference like elements.

FIG. 1 is a cross-sectional view that shows a configuration of a liquid crystal device according to an embodiment of the invention.

FIG. 2 is a block diagram that shows an electrical configuration of the liquid crystal device.

FIG. 3 is a circuit diagram that shows a configuration of a pixel circuit.

FIG. 4 is a timing chart that illustrates an operation of the liquid crystal device.

FIG. 5 is a perspective view that shows an embodiment of an electronic apparatus (personal computer) according to the invention.

FIG. 6 is a perspective view that shows an embodiment of an electronic apparatus (cellular phone) according to the invention.

FIG. 7 is a perspective view that shows an embodiment of an electronic apparatus (personal digital assistants) according to the invention.

### DESCRIPTION OF EXEMPLARY EMBODIMENTS

### A: Liquid Crystal Device

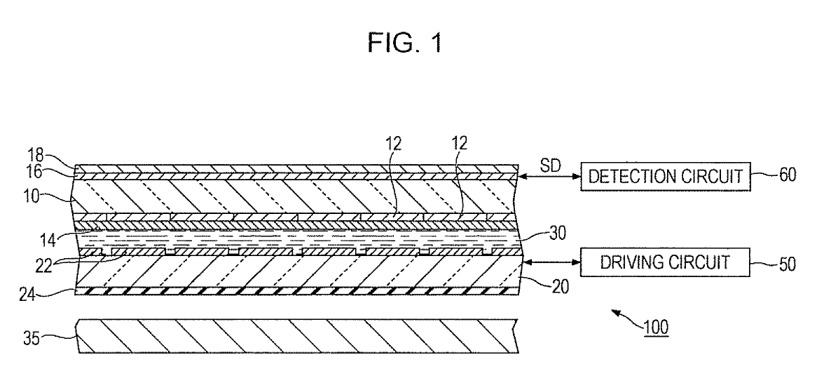

FIG. 1 is a cross-sectional view that shows a configuration of a liquid crystal device according to one embodiment of the invention. The liquid crystal device 100 is a capacitance type touch panel liquid crystal display device provided with a function to display an image by means of optical action of liquid crystal and a function to detect the position of a portion which a finger or a pen contacts or accesses (hereinafter, referred to as “contact portion”).

The liquid crystal device 100 includes an optically transparent first substrate 10 and an optically transparent second substrate 20, which are opposed to each other, and liquid crystal 30 sealed in a gap between the substrates. A plurality of pixel electrodes 22 are formed on a surface of the second substrate 20, opposite the first substrate 10, so as to be spaced apart from each other. The plurality of pixel electrodes 22 are arranged on the surface of the second substrate 20 in a matrix. The driving circuit 50 shown in FIG. 1 varies alignment of the liquid crystal 30 in units of pixel electrode 22 by controlling an electric potential of each pixel electrode 22.

A plurality of pigmented layers 12 that are opposed to the pixel electrodes 22 and an optically transparent opposite electrode 14 that continuously extends over the entire face of the first substrate 10 are formed on the surface of the first substrate 10, opposite the second substrate 20. Each of the pigmented layers 12 selectively passes a component of wavelength corresponding to any one of a plurality of colors (red color, green color, blue color) among rays of light that travel from the liquid crystal 30 toward the first substrate 10. The opposite electrode 14 is opposed to the plurality of pixel electrodes 22 with the liquid crystal 30 interposed therebetween. Note that, in FIG. 1, an alignment layer and a seal material are not shown in the drawing appropriately.

A detection electrode 16 is formed on the surface of the first substrate 10, which is on the opposite side (outer side) relative to the liquid crystal 30. The detection electrode 16 is an optically transparent conductive film for detecting a contact on the basis of variation in capacitance. The detection electrode 16 of the present embodiment is continuously distributed all over the first substrate 10.

A detection circuit 60 shown in FIG. 1 detects an electrical signal (hereinafter, referred to as “detection signal”) SD from the detection electrode 16 and specifies the position of a contact portion on the basis of the detection signal SD. For example, the detection circuit 60, when a common alternating voltage is applied to a plurality of terminals (for example, four corners) of the detection electrode 16, detects electric currents flowing from the terminals to the contact portion as the detection signals SD, and then specifies the position of the contact portion on the basis of electric current values of the detection signals SD. However, an embodiment of the detection electrode 16 may be selected. For example, a configuration in which a plurality of the detection electrodes 16 are arranged in a matrix may also be employed. The detection circuit 60 specifies the position of a contact portion on the basis of the detection signals SD acquired from the detection electrodes 16 of each row and each column.

A polarizer 18 is adhered on the face of the detection electrode 16. Similarly, a polarizer 24 is adhered on the face of the second substrate 20, which is on the opposite side relative to the liquid crystal 30. A lighting device 35 is provided on the rear side of the liquid crystal device 100 (on the opposite side relative to the liquid crystal 30 as viewed from the second substrate 20). Light emitted from the lighting device 35 passes through the second substrate 20, the liquid crystal 30, the opposite electrode 14, the pigmented layers 12, the first substrate 10 and the detection electrode 16, in the stated order, and exits toward a viewer's side, thus displaying an image.

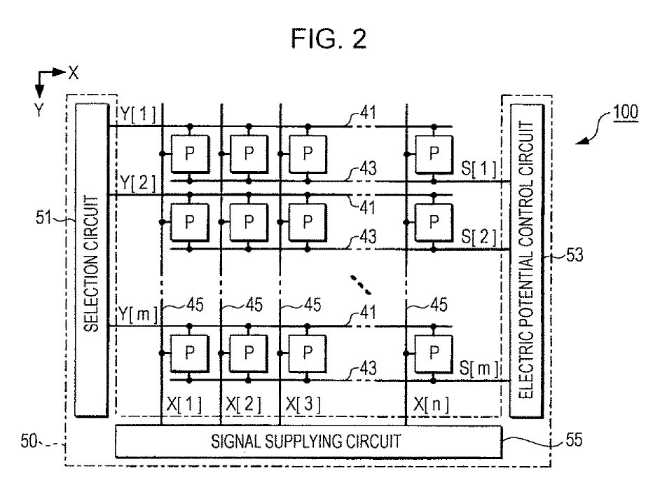

FIG. 2 is a block diagram that shows an electrical configuration of elements of the liquid crystal device 100 for displaying an image. As shown in FIG. 2, m selection lines 41, m capacitor lines 43, n signal lines 45 are formed on the second substrate 20 (m and n are natural numbers). The selection lines 41 extend in an X direction. The capacitor lines 43 are in pairs with the selection lines 41 and extend in the x direction. The signal lines 45 extend in a Y direction perpendicular to the X direction. Pixel circuits P are arranged at positions corresponding to intersections of the selection lines 41 and the signal lines 45. Thus, the pixel circuits P are arranged in a matrix of m rows X and n columns along the X direction and the Y direction.

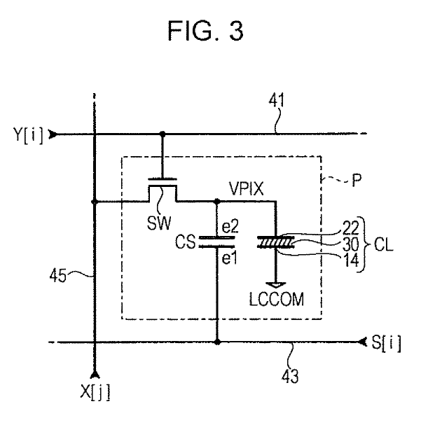

FIG. 3 is a circuit diagram that shows a configuration of one of the pixel circuits P. In the drawing, only one pixel circuit P in the j-th column (j=1 to n), belonging to the i-th row (i=1 to m), is typically shown. As shown in FIG. 3, the pixel circuit P includes a liquid crystal capacitor CL, a storage capacitor CS and a switching element SW. A liquid crystal capacitor CL is a capacitor that is formed of the pixel electrode 22, the opposite electrode 14, and the liquid crystal 30 that is held between the electrodes. The electric potential of the opposite electrode 14 is maintained at an electric potential (fixed electric potential) LCCOM supplied from a power supply circuit (not shown).

A storage capacitor CS includes a first electrode e1 and a second electrode e2. The second electrode e2 is electrically connected to the pixel electrode 22 of the liquid crystal capacitor CL. The first electrodes e1 of the pixel circuits P in the i-th row are commonly connected to the i-th capacitor line 43.

The switching element SW of each pixel circuit P in the M-th column is an n-channel thin-film transistor that is connected between the pixel electrode 22 and the j-th column signal line 45 to control electrical connection (conduction or non-conduction) therebetween. The gates of the switching elements SW of the pixel circuits P in the i-th row are commonly connected to the i-th selection line 41.

As shown in FIG. 2, the driving circuit 50 includes a selection circuit 51, an electric potential control circuit 53 and a signal supplying circuit 55. Note that the driving circuit 50 may be formed of a single integrated circuit or may be formed of multiple integrated circuits. In addition, the driving circuit 50 may be formed of switching elements (thin-film transistors) that are formed on the surface of the second substrate 20 together with the switching elements SW of the pixel circuits P.

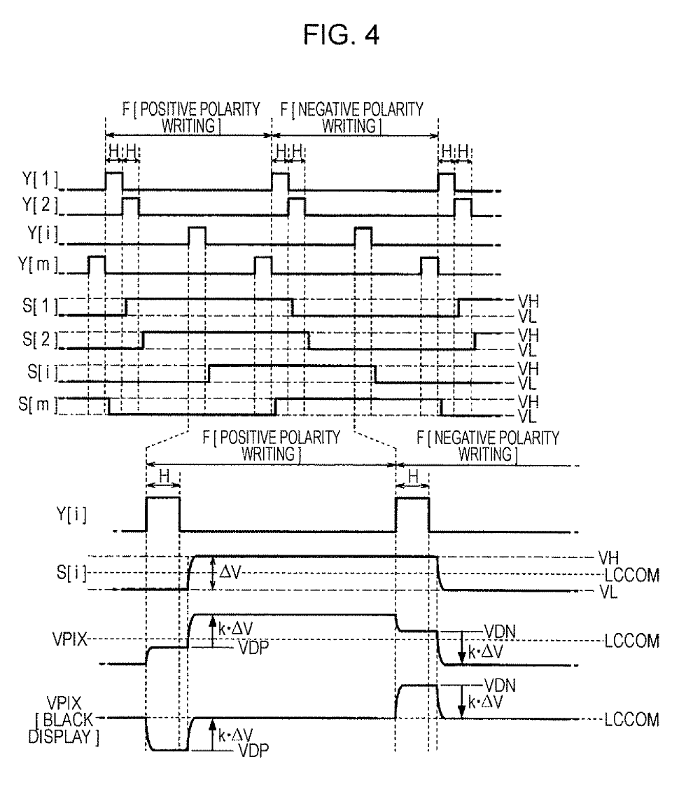

FIG. 4 is a timing chart that illustrates an operation of the liquid crystal device 100. The selection circuit 51 generates selection signals Y[1] to Y[m] for sequentially selecting m selection lines 41 (pixel circuits P in the rows), and outputs them to the selection lines 41. As shown in FIG. 4, a selection signal Y[i] supplied to the i-th selection line 41 is at an active level (high level) during the i-th selection period (horizontal scanning period) H within a single frame period F, and maintains a low level during a period other than the selection period H. Thus, the switching element SW of each pixel circuit P in the i-th row is conducted during the i-th selection period H within the frame period F and, after the selection period H has elapsed, is shifted into a non-conductive state.

The signal supplying circuit 55 shown in FIG. 2 generates data signals X[1] to X[n] that specify the gray scale levels of the pixel circuits P and outputs them to the corresponding signal lines 45. A data signal X[j] supplied to the j-th column signal line 45 is applied with an electric potential VD (VDP or VDN) corresponding to a gray scale level that is specified by the j-th column pixel circuit P in the i-th row during a selection period H when the selection signal Y[i] is at a high level.

The liquid crystal device 100 employs a frame inversion driving method in which a polarity of voltage applied to the liquid crystal capacitor CL is inverted every frame period F. The data signal X[j] is set to an electric potential VDP during a selection period H within a frame period F when a voltage of positive polarity is being applied to the liquid crystal capacitor CL (hereinafter, referred to as “positive polarity writing”) and is set to an electric potential VDN during a selection period H within a frame period F when a voltage of negative polarity is being applied to the liquid crystal capacitor CL (hereinafter, referred to as “negative polarity writing”).

The electric potential control circuit 53 generates control signals S[1] to S[m] for determining voltages applied to the liquid crystal capacitors CL of the pixel circuits P and outputs them to the corresponding capacitor lines 43. An electric potential of a control signal S[i] supplied to the i-th capacitor line 43 (the first electrode e1 of each pixel circuit P in the i-th row) is shifted from one of the electric potential VH and the electric potential VL to the other after the selection period H during which the selection signal Y[i] is at a high level has elapsed, as shown in FIG. 4. The electric potential VH is higher in potential than the electric potential VL. As shown in FIG. 4, the control signal S[i] rises from the electric potential VL to the electric potential VH after the i-th selection period H in the frame period F during which the positive polarity writing is performed has elapsed and falls from the electric potential VH to the electric potential VL after the i-th selection period H in the frame period F during which the negative polarity writing is performed has elapsed.

Next, the operation of the j-th column pixel circuit P in the i-th row will be described. As the selection signal Y[i] is shifted into a high level in the selection period H, the switching element SW is conducted and thereby the pixel electrode 22 and the corresponding signal line 45 are electrically connected to each other. Thus, as shown in FIG. 4, an electric potential VPIX of the pixel electrode 22 and second electrode e2 is set to the electric potential VDP of the data signal [j] in the selection period H in the frame period F during which the positive polarity writing is performed and is set to the electric potential VDN of the data signal X[j] in the selection period H in the frame period F during which the negative polarity writing is performed.

As the selection signal Y[i] is shifted to a low level with the lapse of the selection period H, the switching element SW is changed to a non-conductive state and thereby the pixel electrode 22 and the second electrode e2 enter an electrically floating state. Thus, as the electric potential of the control signal S[i] supplied to the first electrode e1 changes after the selection period H has elapsed, the electric potential VPIX of the pixel electrode 22 and second electrode e2 varies from the electric potential VD (VDP, VDN), which is set in the selection period H, on the basis of an amount of change ΔV (ΔV=VH−VL) in electric potential of the first electrode e1.

That is, because the control signal S[i] rises from the electric potential VL to the electric potential VH after the selection period H during which the positive polarity writing is performed has elapsed, the electric potential VPIX rises from the electric potential VDP, which is set in the preceding selection period H, by an amount of change k·ΔV. In addition, because the control signal S[i] falls from the electric potential VH to the electric potential VL after the selection period H during which the negative polarity writing is performed has elapsed, the electric potential VPIX falls from the preceding electric potential VDN by an amount of change k·ΔV. The coefficient k is a numerical value (k=cS/(cS+cL)) corresponding to a capacitance value cL of the liquid crystal capacitor CL and a capacitance value cS of the storage capacitor CS. The electric potential VPIX of the pixel electrode 22 is maintained at the electric potential (VD±k·ΔV), after it has been varied, corresponding to the control signal S[i] until the selection signal Y[i] attains a high level next time.

The electric potential VD of the data signal X[j] during the selection signal H is set so that the electric potential VPIX, after it has been changed, corresponding to variation in the control signal S[i] (a voltage applied to the liquid crystal capacitor CL) becomes an electric potential corresponding to a gray scale level specified by the pixel circuit P. For example, in a case where a normally black mode is assumed, in which a gray scale level (transmission ratio) decreases as the voltage of the liquid crystal capacitor CL decreases, when a gray scale level of black color is specified by the pixel circuit P (lower side of FIG. 4), the electric potential VD of the data signal X[j] is set so that the electric potential VPIX, which is varied after the selection period H, substantially coincides with the electric potential LCCOM of the opposite electrode 14.

In the above described embodiment, because the electric potential VPIX of the pixel electrode 22 is set to an electric potential that is obtained by varying the electric potential VD of the data signal X[j] on the basis of the control signal S[i], in comparison with a configuration in which the electric potential of the first electrode e1 is fixed, the amplitude of the data signal X[j] necessary to control the electric potential VPIX of the pixel electrode 22 over a predetermined range is suppressed. Thus, without requiring an exclusive circuit, for example, described in JP-A-2006-146895, that removes noise from the detection signal SD or a shield that suppresses an influence of variation in the electric potential VPIX on the detection electrode 16, it is possible to reduce noise generated in the detection electrode 16 on the basis of variation in the data signal X[j] (furthermore, to specify the position of a contact with high accuracy).

In addition, in the present embodiment, the detection electrode 16 is formed on the surface of the first substrate 10. Thus, in comparison with a configuration in which the detection electrode 16 is adhered onto a substrate that is independent of the first substrate 10 and the substrate is then fixed to the first substrate 10 (hereinafter, referred to as “first comparative embodiment”), a reduction in the number of components of the liquid crystal device 100 and/or a thin-shaped liquid crystal device 100 may be realized. Moreover, it is advantageous in that usability of light emitted from the lighting device 35 is improved by an amount a substrate exclusively used for adhering the detection electrode 16 is omitted. Note that, in the present embodiment, because noise of the detection electrode 16 is suppressed by suppressing the amplitude of the data signal X[j], it is possible to sufficiently suppress noise of the detection electrode 16 by directly forming the detection electrode 16 on the first substrate 10 in spite of a configuration in which the detection electrode 16 is located in proximity to the pixel electrode 22 in comparison with the first comparative embodiment (that is, a configuration in which noise in accordance with variation in VPIX is likely to be generated in the detection electrode 16). That is, the advantageous effects of the aspects of the invention, in which the amplitude of the data signal X[j] is suppressed, is particularly effective for a configuration in which the detection electrode 16 is directly formed on the first substrate 10,

### B: Alternative Embodiments

The above described embodiments may be modified into various alternative embodiments. Specific alternative embodiments may be exemplified as follows. Note that the following embodiments may be appropriately combined.

### (1) First Alternative Embodiment

In the above described embodiment, the configuration in which the electric potential LCCOM of the opposite electrode 14 is fixed, a configuration may also be employed in which the electric potential LCCOM varies in synchronization with switching between the positive polarity writing and the negative polarity writing. In this configuration as well, by varying the electric potential VPIX on the basis of the control signal S[i] after the selection period H has elapsed, the advantageous effect in which noise of the detection electrode 16 due to variation in data signal X[j] is suppressed is absolutely obtained. However, because noise due to variation in electric potential LCCOM can be generated in the detection electrode 16, in view of effectively reducing noise of the detection electrode 16, the configuration in which the electric potential LCCOM is fixed as in the case of the embodiment is suitable.

### (2) Second Alternative Embodiment

In the above embodiments, the frame inversion driving method in which positive polarity writing and negative polarity writing are alternately performed every frame period is exemplified; however, a period of switching between positive polarity writing and negative polarity writing is not limited to a frame period F. For example, line inversion driving method in which positive polarity writing and negative polarity writing are alternately performed every selection period H (in units of row) or dot inversion driving method in which positive polarity writing and negative polarity writing are alternately performed every pixel circuit P adjacently arranged in an X direction and in a Y direction may also be employed Furthermore, positive polarity writing and negative polarity writing may be switched in units of a plurality of frame periods F.

### (3) Third Alternative Embodiment

In the above described embodiment, the configuration in which the opposite electrode 14 is formed on the first substrate 10 is exemplified, the aspects of the invention may also be applied to an FF5 (Fringe Field Switching) mode or an IPS (In-Plane Switching) mode liquid crystal device, in which the opposite electrode 14 is formed on the second substrate 20 together with the pixel electrodes 22. Thus, the aspects of the invention are also applicable to a configuration in which the opposite electrode 14 is formed on a side of the pixel electrode 22, opposite to a side on which the detection electrode 16 is formed. However, in the configuration in which the opposite electrode 14 is interposed between the pixel electrode 22 and the detection electrode 16 (moreover, the configuration in which the electric potential LCCOM of the opposite electrode 14 is fixed) as shown in FIG. 1, because the opposite electrode 14 functions as a shield for suppressing an influence of variation in the selection signal Y[i] and/or the data signal X[j] on the detection electrode 16, it is advantageous in that, in comparison with the configuration in which the pixel electrodes 22 are interposed between the opposite electrode 14 and the detection electrode 16, it is possible to effectively suppress noise of the detection electrode 16.

### (4) Fourth Alternative Embodiment

An alignment mode of the liquid crystal 30 may be selected. For example, the aspects of the invention are applicable to the liquid crystal device 100 that uses various modes of liquid crystal 30, such as TN (Twisted Nematic) mode, VA (Vertical Alignment) mode, or ECB (Electrically Controlled Birefringence) mode. Furthermore, in the above described embodiments, the configuration in which the plurality of pixel electrodes 22 are arranged in a matrix is exemplified; however, the shape and/or arrangement of the pixel electrodes 22 may be selected. For example, it is applicable that the shape, number and/or arrangement of the pixel electrodes 22 are selected so as to match an image of an operator that indicates a portion to be operated by a user.

### C: Application Embodiments

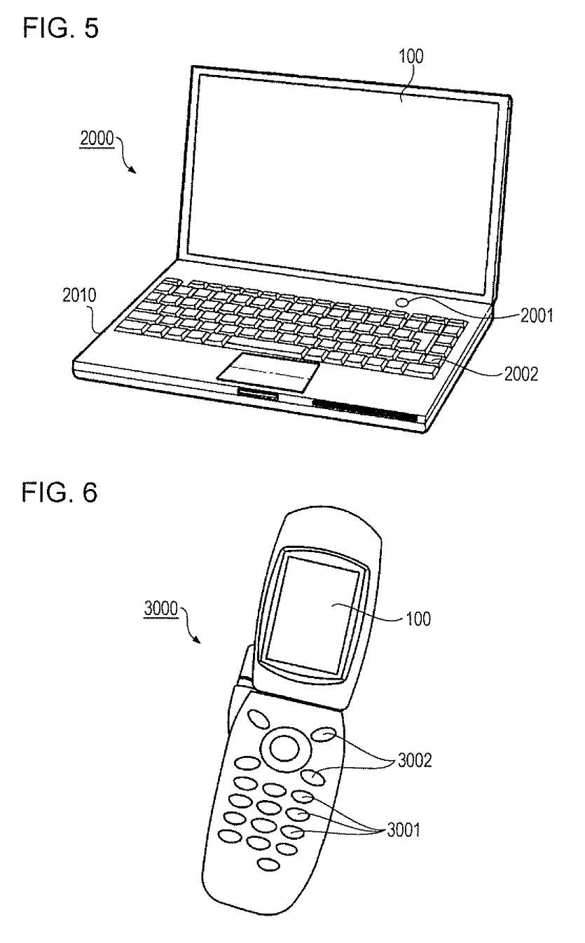

Next, electronic apparatuses that employ the liquid crystal device according to the aspects of the invention will be described. In FIG. 5 to FIG. 7, embodiments of electronic apparatuses that use the liquid crystal device 100 according to any one of the embodiments described above as a display device are shown.

FIG. 5 is a perspective view that shows a configuration of a mobile personal computer that uses the liquid crystal device 100. The personal computer 2000 includes the liquid crystal device 100 that displays various images and a body portion 2010 that has a power switch 2001 and a keyboard 2002.

FIG. 6 is a perspective view that shows a configuration of a cellular phone to which the liquid crystal device 100 is applied. The cellular phone 3000 includes a plurality of operation buttons 3001, a plurality of scroll buttons 3002, and the liquid crystal device 100 that displays various images. By manipulating the scroll buttons 3002, an image displayed on the liquid crystal device 100 is scrolled.

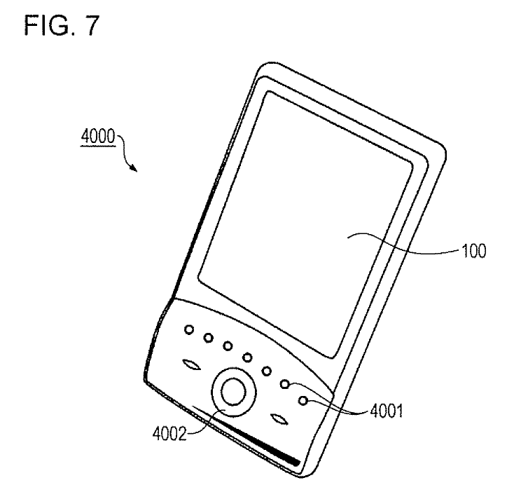

FIG. 7 is a perspective view that shows a configuration of a personal digital assistants (PDA) to which the liquid crystal device 100 is applied. The personal digital assistants 4000 includes a plurality of operation buttons 4001, a power switch 4002, and the liquid crystal device 100 that displays various images. As the power switch 4002 is manipulated, various pieces of information, such as an address book and a schedule book, are displayed on the liquid crystal device 100.

Note that the electronic apparatuses that employ the liquid crystal device according to the aspects of the invention include, in addition to the apparatuses shown in FIG. 5 to FIG. 7, a digital still camera, a television, a video camera, a car navigation system, a pager, an electronic personal organizer, an electronic paper, an electronic calculator, a word processor, a workstation, a video telephone, a POS terminal, a printer, a scanner, a photocopier, and a video player.

What is claimed is:

1. A liquid crystal device comprising:
a first substrate;
a second substrate that is opposed to the first substrate;
liquid crystal that is sealed in a gap between the first substrate and the second substrate;
a detection electrode that is provided on a side of the first substrate, opposite to a side on which the liquid crystal is provided, wherein the detection electrode detects a contact on the basis of variation in capacitance;
a liquid crystal capacitor that includes a pixel electrode, an opposite electrode, and the liquid crystal between the pixel electrode and the opposite electrode;
a storage capacitor that includes a first electrode and a second electrode that is connected to the pixel electrode;
a switching element that is connected between the pixel electrode and a signal line;
a selection circuit that conducts the switching element during a selection period and interrupts conduction of the switching element after the selection period has elapsed;
a signal supplying circuit that supplies a data electric potential corresponding to positive polarity writing or negative polarity writing to the signal line during the selection period; and
an electric potential control circuit that shifts an electric potential of the first electrode to a high level side after a selection period in which a data electric potential corresponding to the positive polarity writing is supplied to the signal line has elapsed, and that shifts an electric potential of the first electrode to a low level side after a selection period in which a data electric potential corresponding to the negative polarity writing is supplied to the signal line has elapsed.

2. The liquid crystal device according to claim 1, wherein the detection electrode is formed on a surface of the first substrate, which is opposite to a surface on which the liquid crystal is provided.

3. The liquid crystal device according to claim 1, wherein the pixel electrode is formed on a surface of the second substrate, which is opposite to the first substrate, and wherein the opposite electrode is formed between the pixel electrode and the first substrate and maintained at a constant electric potential.

4. An electronic apparatus comprising the liquid crystal device according to claim 1.

5. A method of driving a liquid crystal device that includes a first substrate, a second substrate opposed to the first substrate, liquid crystal sealed in a gap between the first substrate and the second substrate, a liquid crystal capacitor that has a pixel electrode, an opposite electrode and the liquid crystal between the pixel electrode and the opposite electrode, a storage capacitor that has a first electrode and a second electrode connected to the pixel electrode, and a detection electrode formed on a side of the first substrate, opposite to a side on which the liquid crystal is provided, wherein the detection electrode is used for detecting a contact on the basis of variation in capacitance, the method comprising:
connecting the pixel electrode and the signal line during a selection period and interrupting the pixel electrode from the signal line after the selection period has elapsed;
supplying the signal line during the selection period with a data electric potential corresponding to positive polarity writing or negative polarity writing; and
shifting an electric potential of the first electrode to a high level side after a selection period in which a data electric potential corresponding to the positive polarity writing is supplied to the signal line has elapsed and shifting an electric potential of the first electrode to a low level side after a selection period in which a data electric potential corresponding to the negative polarity writing is supplied to the signal line has elapsed.
